(19) United States
(12) Patent Application Publication
(10) Pub. No.: US 2019/0280837 A1
(43) Pub. Date: Sep. 12, 2019

(54) USER EQUIPMENT AND BASE STATION

(71) Applicant: NTT DOCOMO, INC., Tokyo (JP)

(72) Inventors: Yousuke Sano, Tokyo (JP); Kazuaki Takeda, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/343,657

(22) PCT Filed: Oct. 30, 2017
(86) PCT No.: PCT/JP2017/039173

§ 371 Date: Apr. 19, 2019

(30) Foreign Application Priority Data
Nov. 2, 2016 (JP) 2016-215711

(51) Int. Cl. H04L 5/00; H04W 72/04

(52) U.S. Cl. CPC H04L 5/0048; H04W 72/04

(57) ABSTRACT

Disclosed is a reference signal transmission scheme in which interference between adjacent cells is considered in a communication scheme in which uplink communication and downlink communication are dynamically switched. A feature of the present invention relates to a user equipment including a transmitting and receiving unit that performs transmission and reception of a radio signal with a base station in accordance with a communication scheme in which uplink communication and downlink communication are dynamically switched and a signal processing unit that processes the radio signal, wherein the transmitting and receiving unit transmits an uplink reference signal generated by the signal processing unit in fixed uplink radio resources in the communication scheme.

### TECHNICAL FIELD

The present invention relates to a radio communication system.

### BACKGROUND ART

In third generation partnership project (3GPP), next generation communication standards (5G and NR) of long term evolution (LTE) and LTE-advanced have been discussed. In the NR system, flexible duplex has been studied in which resources used for downlink communication and uplink communication are flexibly controlled in accordance with downlink traffic and uplink traffic to be generated. For example, dynamic time division duplex (TDD) has been studied in which uplink resources and downlink resources are dynamically switched in the time domain. Additionally, a scheme has been studied in which switching is performed in a frequency domain, and full duplex has been studied in which uplink communication and downlink communication are simultaneously performed using the same resources. For simplicity of the description, an example of dynamic TDD is described below. Note that the same applies to other schemes. Typically, in a small cell, deviation between the downlink traffic and the uplink traffic is assumed to be larger than that in a large cell. Accordingly, by individually controlling, in each cell, downlink communication and uplink communication using the dynamic TDD, traffic can be more efficiently accommodated.

In the dynamic TDD, downlink and uplink communication directions are dynamically switched at certain time intervals, such as subframes, slots, mini slots, or the like. Namely, as illustrated in FIG. 1A, in static TDD applied in LTE, a preconfigured downlink/uplink pattern common to cells is used. In contrast, in the dynamic TDD, as illustrated in FIG. 1B, an individual downlink/uplink pattern is used for each cell. Accordingly, each cell can dynamically change the downlink and uplink communication directions in accordance with downlink and uplink traffic volumes.

In the NR system, various types of reference signals are assumed to be transmitted, such as a reference signal for data demodulation (a demodulation reference signal (DMRS) signal or the like), a channel state information-reference signal (CSI-RS) for downlink channel quality measurement, a sounding reference signal (SRS) for uplink channel quality measurement, and a reference signal for transmission beam control. For example, in the LTE system, the CSI-RS signal and the SRS signal are mapped to radio resources, as illustrated in FIGS. 2A and 2B, respectively. In coordinated multi-point operation (CoMP) in which a radio signal is cooperatively transmitted to user equipment (UE) at a cell edge at which interference is caused from an adjacent cell, a non-zero power CSI-RS and a zero power CSI-RS are appropriately combined to implement flexible interference control. For example, in Rel-11 of LTE, as illustrated in FIG. 3, a plurality of CSI-RS processes are configured, and user equipment can estimate interference signal power with signal power from a serving cell and/or a cooperative cell.

### PRIOR ART DOCUMENT

### Non-Patent Document

Non-Patent Document 1: 3GPP TS36.211 V14.0.0 (September 2016)
Non-Patent Document 2: 3GPP TS36.213 V14.0.0 (2016-09)

### SUMMARY OF THE INVENTION

### Problem to be Solved by the Invention

When dynamic TDD is applied, a transmission direction may be different between adjacent cells. In this case, as interference from the adjacent cell, two types of interference are assumed, which are interference from a transmitter of the adjacent cell performing transmission in a direction that is the same as a direction of a desired signal from a transmitter of a corresponding cell and interference from the transmitter of the adjacent cell performing transmission in a direction different from the direction of the desired signal from the transmitter of the corresponding cell (crosslink interference). For example, in an example in which a target user equipment illustrated in FIG. 4 transmits an uplink signal to a serving base station, the serving base station is assumed to receive interference caused by uplink transmission from the user equipment of the adjacent cell performing transmission in the same direction as the direction of the uplink signal (UE-BS interference in the example illustrated in FIG. 4) and interference caused by downlink transmission from an adjacent base station performing transmission in a direction different from the direction of the uplink signal (BS-BS interference in the example illustrated in FIG. 4). Further, for example, when the CSI-RS signal is transmitted as the downlink reference signal in the cell, downlink channel quality measurement may be unable to be appropriately performed due to interference from the uplink signal in the adjacent cell (UE-UE interference). Furthermore, it is desirable that flexible interference measurement using a plurality of CSI-RS processes as illustrated in FIG. 3 can be allowed for interference measurement in downlink or uplink communication.

In view of the above-described problem, an object of the present invention is to provide a reference signal transmission scheme in which interference between adjacent cells is considered in a radio communication system (for example, dynamic TDD) in which uplink communication and downlink communication can be dynamically switched.

### Means for Solving the Problem

In order to solve the above-described problem, an aspect of the present invention relates to user equipment including a transmitting and receiving unit that performs transmission and reception of a radio signal with a base station in accordance with a communication scheme in which uplink communication and downlink communication are dynamically switched and a signal processing unit that processes the radio signal, wherein the transmitting and receiving unit transmits an uplink reference signal generated by the signal processing unit in fixed uplink radio resources in the communication scheme.

### Advantage of the Invention

According to the present invention, a reference signal transmission scheme can be provided in which interference between adjacent cells is considered in a radio communication system in which uplink communication and downlink communication can be dynamically switched.

### BRIEF DESCRIPTION OF DRAWINGS

FIGS. 1A and 1B are schematic diagrams illustrating specific examples of static TDD and dynamic TDD;

FIGS. 2A and 2B are schematic diagrams illustrating mapping examples of downlink and uplink reference signals in LTE;

FIG. 3 is a schematic diagram illustrating a combination of non-zero power and zero power CSI-RSs;

FIG. 4 is a schematic diagram illustrating an interference pattern assumed in dynamic TDD;

FIG. 5 is a schematic diagram illustrating UL/DL patterns of dynamic TDD according to one embodiment of the present invention;

FIG. 6 is a schematic diagram illustrating a radio communication system according to one embodiment of the present invention;

FIG. 7 is a block diagram illustrating a functional configuration of a user equipment according to one embodiment of the present invention;

FIG. 8 is a block diagram illustrating a functional configuration of a base station according to one embodiment of the present invention;

FIG. 9 is a schematic diagram illustrating mapping of a reference signal in dynamic TDD according to a first embodiment of the present invention;

FIG. 10 is a schematic diagram illustrating mapping of a reference signal in dynamic TDD according to a second embodiment of the present invention;

FIG. 11 is a schematic diagram illustrating mapping of a reference signal in dynamic TDD according to the second embodiment of the present invention;

FIG. 12 is a schematic diagram illustrating mapping of a beamformed reference signal in dynamic TDD according to the second embodiment of the present invention;

FIG. 13 is a schematic diagram illustrating mapping of a reference signal in dynamic TDD according to a third embodiment of the present invention;

FIG. 14 is a schematic diagram illustrating mapping of a reference signal in dynamic TDD according to the third embodiment of the present invention; and

FIG. 15 is a block diagram illustrating a hardware configuration of each of user equipment and a base station according to one embodiment of the present invention.

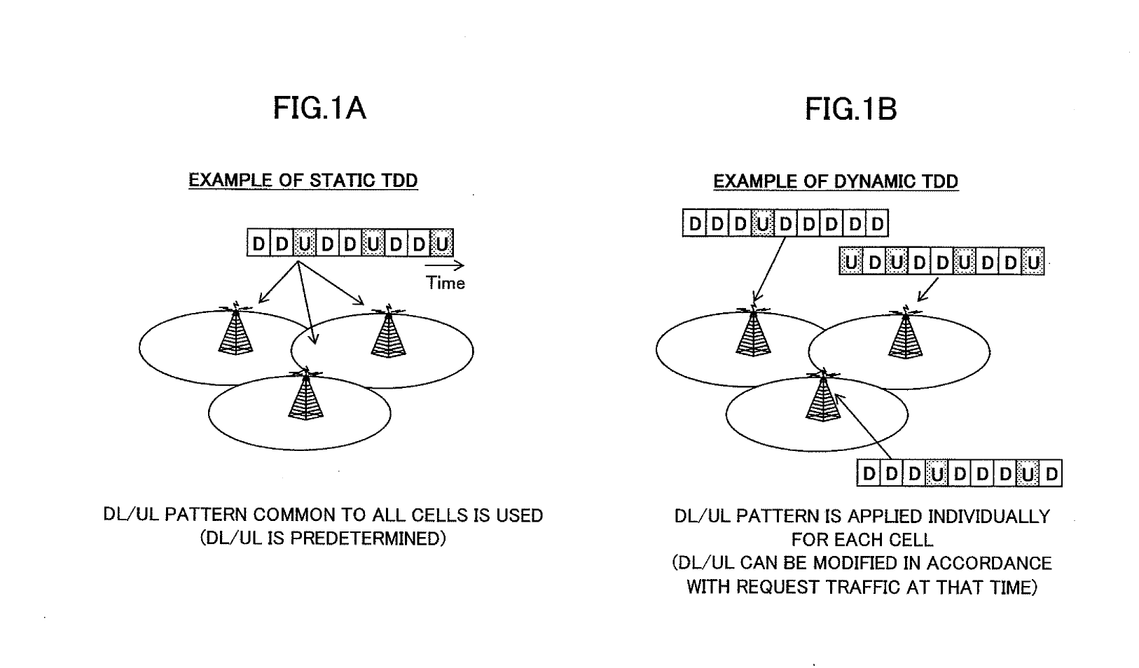

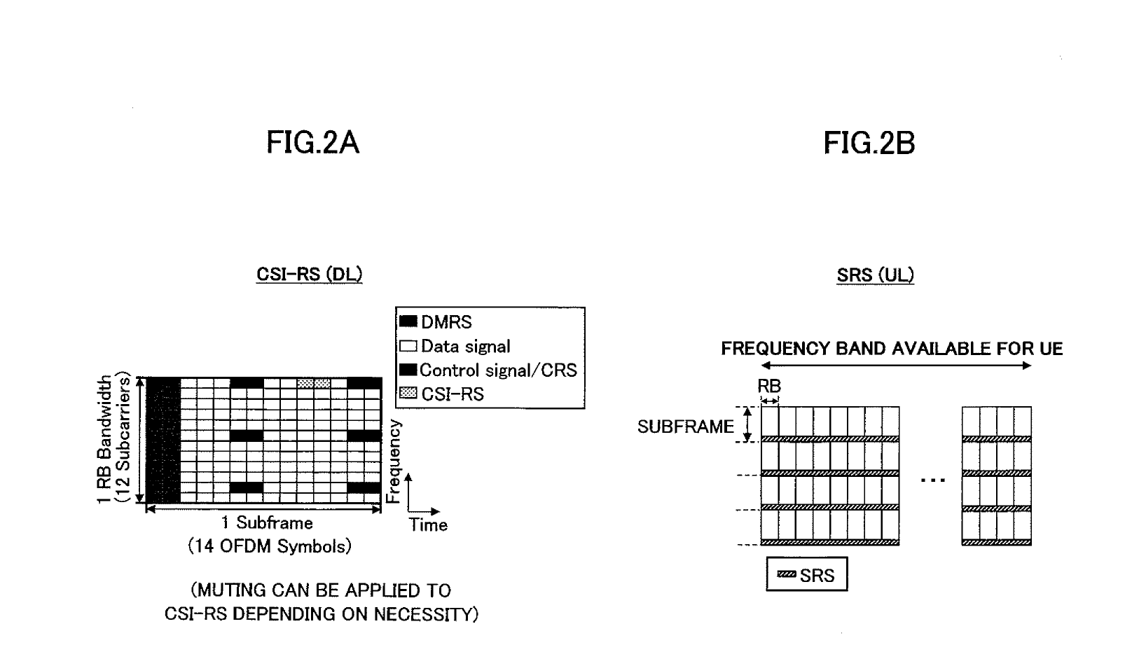

### EMBODIMENTS OF THE INVENTION

Hereinafter, exemplary embodiments of the present invention are described with reference to the appended drawings.

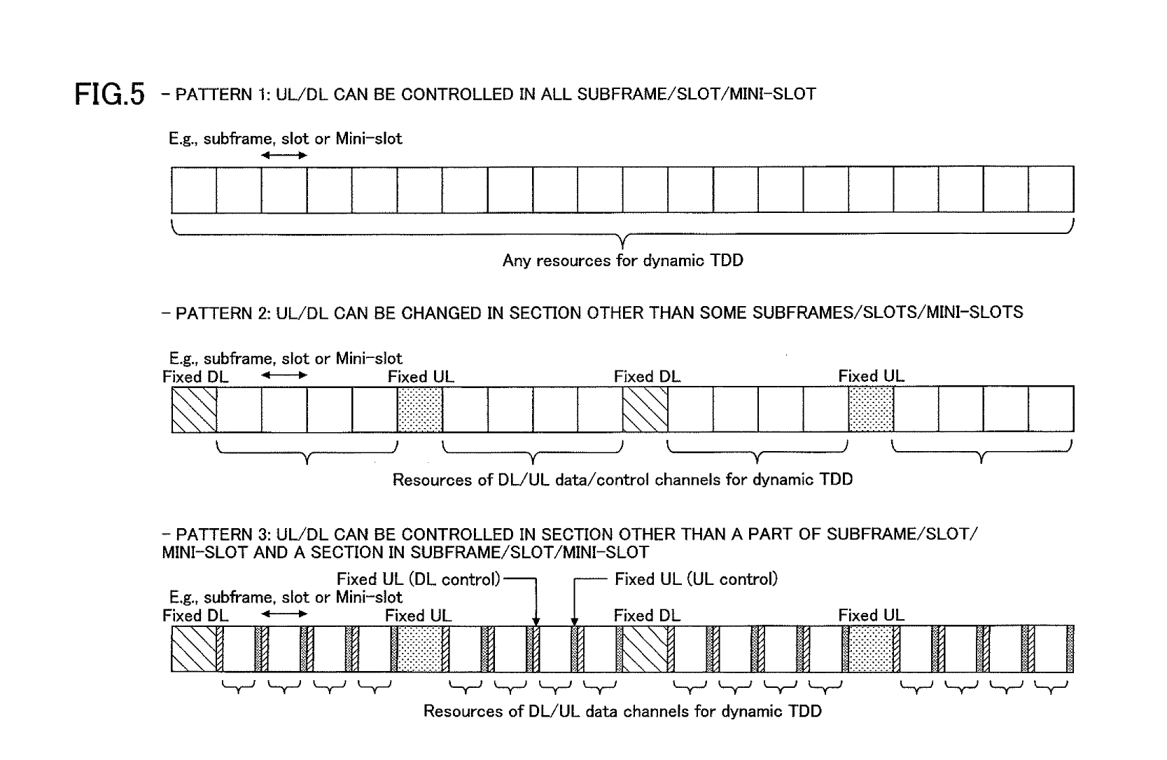

In the following embodiments, a radio communication system to which dynamic TDD is applied is disclosed as an example of a radio communication system in which resources used for downlink communication and uplink communication can be dynamically controlled. However, the present invention is not limited to the dynamic TDD and may be applied to other schemes (for example, a scheme (dynamic FDD) in which uplink resources and downlink resources are switched in the frequency domain or full duplex in which uplink transmission and downlink transmission are performed using the same resources). In the dynamic TDD, for example, as illustrated in FIG. 5, uplink and downlink communications are assumed to be performed in accordance with several uplink/downlink patterns. However, it is an example, and the present invention is not limited thereto. In a pattern 1 illustrated in FIG. 5, the uplink/downlink communication can be performed in all time intervals. In a pattern 2, the uplink/downlink communication is fixedly set in some time intervals, and only a set communication direction is permitted in the corresponding time intervals. On the other hand, in other time intervals, the uplink/downlink communication can be performed. In a pattern 3, the uplink/downlink communication is fixedly set in some time intervals and certain intervals within the time interval (in the example illustrated in FIG. 5, both end sections within the time interval are fixedly set for downlink communication and uplink communication), and only the set communication direction is permitted in the corresponding time intervals. On the other hand, in other time intervals, the uplink/downlink communication can be performed. In one embodiment, the reference signal is transmitted in uplink or downlink radio resources which are fixedly set in the patterns 2 and 3. In another embodiment, in order to prevent the crosslink interference, the reference signal is transmitted in radio resources muted in the adjacent cell. In yet another embodiment, in order to measure inter-cell interference including the crosslink interference, when a radio signal in a certain communication direction is transmitted in radio resources in the adjacent cell, a radio signal in an opposite communication direction is transmitted undergoes muting or zero power in corresponding radio resources of the corresponding cell. When the radio resources undergo muting or zero power, other signals (for example, data signals) may be rate-matched or punctured.

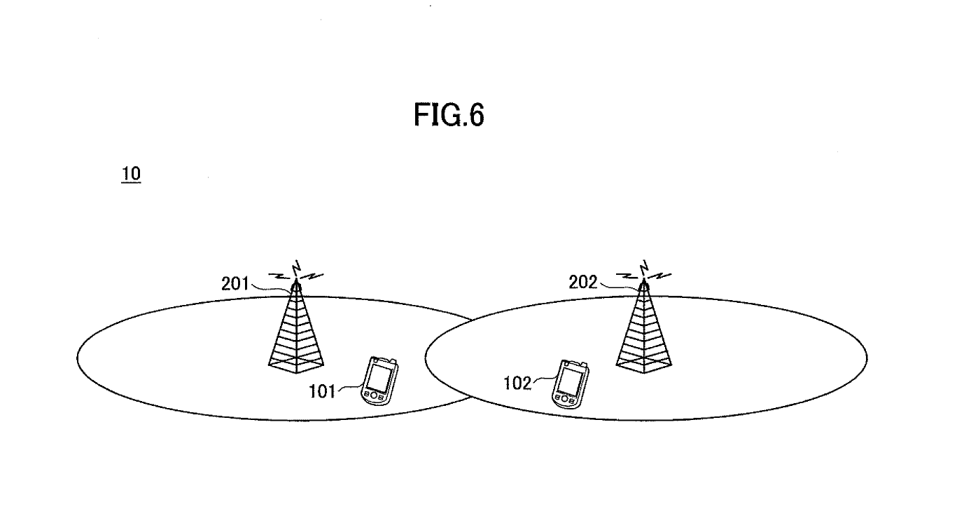

First, a radio communication system according to one embodiment of the present invention is described with reference to FIG. 6. FIG. 6 is a schematic diagram illustrating the radio communication system according to one embodiment of the present invention.

As illustrated in FIG. 6, a radio communication system 10 includes user equipment 101 and user equipment 102 (hereinafter, referred to collectively as a “user equipment 100”) and base stations 201 and 202 (hereinafter, referred to collectively as “base station 200”). In the following embodiments, the radio communication system 10 is a radio communication system (for example, the 5G or NR system) conforming to a standard of Rel-14 or later of 3GPP, but the present invention is not limited thereto, and the radio communication system 10 may be any other radio communication system to which the dynamic TDD is applied.

The user equipment 100 is any appropriate information processing device having a radio communication function such as a smartphone, a mobile phone, a tablet, a wearable terminal, a machine-to-machine (M2M) communication module, or the like, and is wirelessly connected to the base station 200 and uses various kinds of communication services provided in the radio communication system 10.

The base station 200 provides one or more cells and performs radio communication with the user equipment 100. Only two base stations 201 and 202 are illustrated in the illustrated embodiment, but generally, a plurality of base stations 200 are arranged to cover a service area of the radio communication system 10.

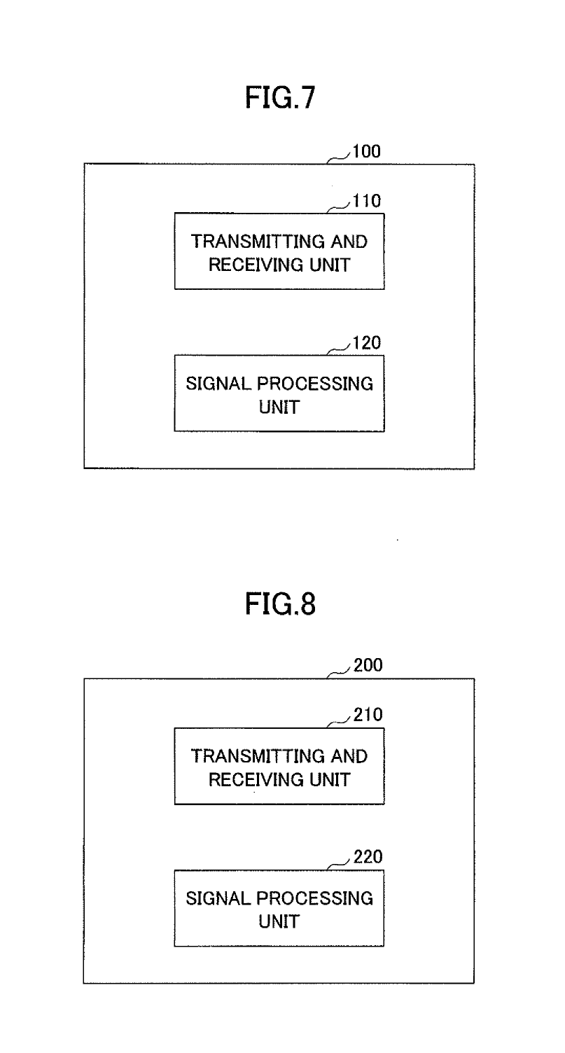

Next, the user equipment according to one embodiment of the present invention is described with reference to FIG. 7. FIG. 7 is a block diagram illustrating the functional configuration of user equipment according to one embodiment of the present invention.

As illustrated in FIG. 7, the user equipment 100 includes a transmitting and receiving unit 110 and a signal processing unit 120.

The transmitting and receiving unit 110 performs transmission and reception of a radio signal with the base station 200 in accordance with a communication scheme in which the uplink communication and the downlink communication are dynamically switched. An example of the communication scheme is the dynamic TDD in which the uplink communication and the downlink communication are dynamically switched in the time domain. Specifically, the transmitting and receiving unit 110 dynamically switches the downlink communication and the uplink communication at predetermined time intervals in accordance with the dynamic TDD, and transmits and performs transmission and reception of an uplink signal and a downlink signal. Here, the time interval may be any appropriate time interval such as a subframe, a slot, a mini slot, or the like.

The signal processing unit 120 processes the radio signal. Specifically, the signal processing unit 120 generates the uplink signal to be transmitted to the base station 200, and provides the generated uplink signal to the transmitting and receiving unit 110. In the present embodiment, as described below, the signal processing unit 120 maps an uplink reference signal (the SRS or the like) to radio resources for uplink transmission, or mutes some radio resources. On the other hand, when the transmitting and receiving unit 110 receives the downlink signal from the base station 200, the signal processing unit 120 processes the downlink signal provided from the transmitting and receiving unit 110 and measures the quality of the downlink channel in accordance with the received downlink reference signal (the CSI-RS or the like). A specific process of the signal processing unit 120 is described below in detail.

Next, the base station according to one embodiment of the present invention is described with reference to FIG. 8. FIG. 8 is a block diagram illustrating a functional configuration of the base station according to one embodiment of the present invention.

As illustrated in FIG. 8, the base station 200 includes a transmitting and receiving unit 210 and a signal processing unit 220.

The transmitting and receiving unit 210 performs transmission and reception of the radio signal with the user equipment 100 in accordance with a communication scheme dynamically switching uplink communication and downlink communication. An example of the communication scheme is the dynamic TDD in which the uplink communication and the downlink communication are dynamically switched in the time domain. Specifically, the transmitting and receiving unit 210 dynamically switches the downlink communication and the uplink communication at predetermined time intervals in accordance with the dynamic TDD, and performs transmission and reception of the uplink signal and the downlink signal. Here, the time interval may be any appropriate time interval such as a subframe, a slot, a mini slot, or the like.

The signal processing unit 220 processes the radio signal. Specifically, the signal processing unit 220 generates the downlink signal to be transmitted to the user equipment 100, and provides the generated downlink signal to the transmitting and receiving unit 210. In the present embodiment, as described below, the signal processing unit 220 maps a downlink reference signal (the CSI-RS or the like) to radio resources for downlink transmission or mutes some radio resources. The radio resources to be used are indicated from the base station 200, for example, through a physical control channel or an upper layer signal. On the other hand, when the transmitting and receiving unit 210 receives the uplink signal from the user equipment 100, the signal processing unit 220 processes the uplink signal provided from the transmitting and receiving unit 210 and measures the quality of the uplink channel in accordance with the received uplink reference signal (the SRS or the like). A specific process of the signal processing unit 220 is described below in detail.

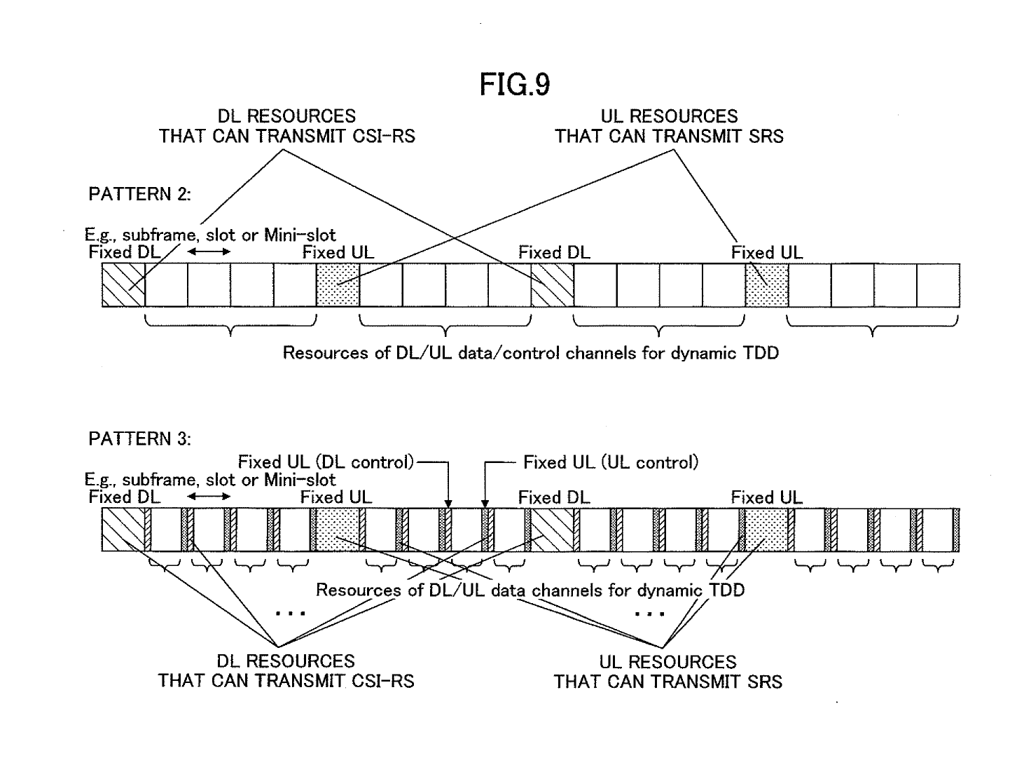

Next, mapping of the reference signal to the radio resources in the dynamic TDD according to a first embodiment of the present invention is described with reference to FIG. 9. In the first embodiment, the uplink and/or downlink reference signals are transmitted in fixedly set uplink and/or downlink radio resources such as the uplink/downlink patterns 2 and 3 in the dynamic TDD described above with reference to FIG. 5.

FIG. 9 is a schematic diagram illustrating the mapping of the reference signal in the dynamic TDD according to the first embodiment of the present invention. As illustrated in FIG. 9, in the first embodiment, the user equipment 100 transmits the uplink reference signal to the base station 200 in the fixed uplink radio resources in the dynamic TDD. On the other hand, the base station 200 transmits the downlink reference signal to the user equipment 100 in the fixed downlink radio resources in the dynamic TDD.

In other words, for the uplink reference signal from the user equipment 100, the transmitting and receiving unit 110 transmits the uplink reference signal generated by the signal processing unit 120 in the fixed uplink radio resources in the dynamic TDD. Specifically, the signal processing unit 120 generates the uplink signal including the uplink reference signal for uplink channel quality measurement such as the SRS, and the transmitting and receiving unit 110 generates the generated uplink signal to the base station 200 in the fixed uplink radio resources in the dynamic TDD. The radio resources to be used are indicated from the base station 200, for example, through the physical control channel or the higher layer signal. In this case, the base station 200 measures the quality of the uplink channel on the basis of the uplink reference signal received in the fixedly set uplink radio resources.

On the other hand, for the downlink reference signal from the base station 200, the transmitting and receiving unit 210 transmits the downlink reference signal generated by the signal processing unit 220 in the fixed downlink radio resources in the dynamic TDD. Specifically, the signal processing unit 220 generates the downlink signal including the downlink reference signal for downlink channel quality measurement such as the CSI-RS, and the transmitting and receiving unit 210 transmits the generated downlink signal to the user equipment 100 in the fixed downlink radio resources in the dynamic TDD. In this case, the user equipment 100 measures the quality of the downlink channel on the basis of the downlink reference signal received in the fixedly set downlink radio resources.

According to the first embodiment, when the same uplink/downlink pattern is used between the adjacent cells, it is possible to measure the channel quality with no crosslink interference from the adjacent cell.

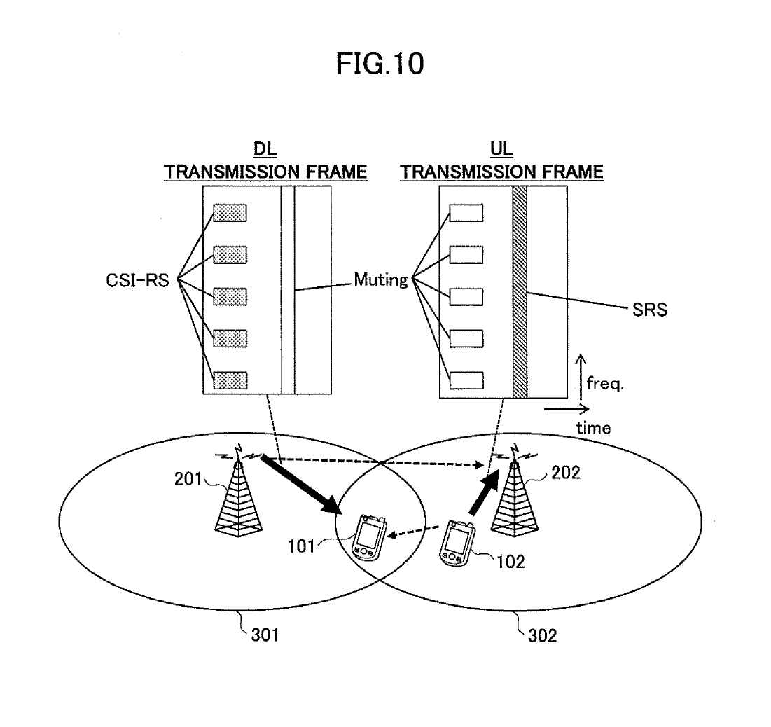

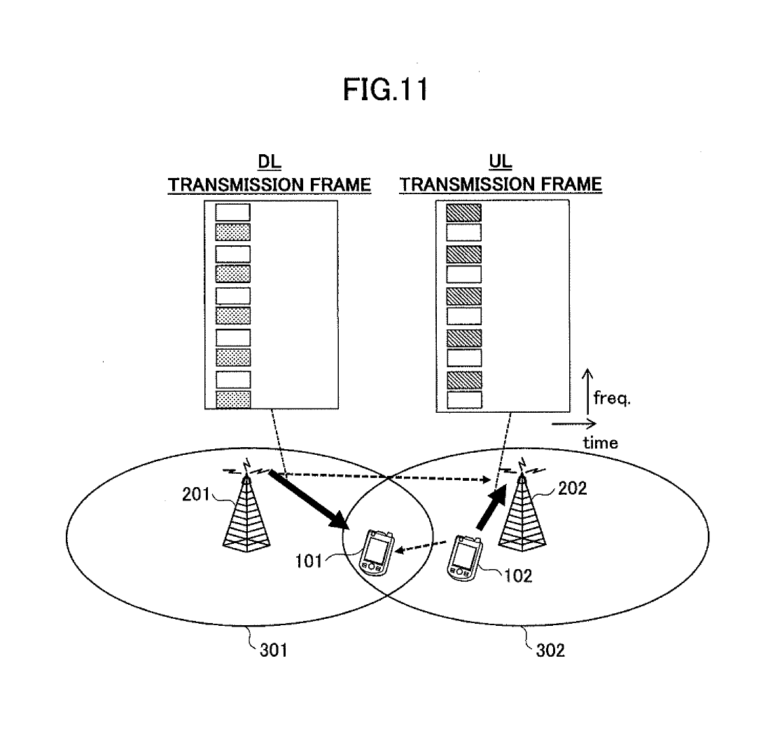

Next, mapping of the reference signal to the radio resources in the dynamic TDD according to a second embodiment of the present invention is described with reference to FIGS. 10 to 11. In the second embodiment, the uplink and/or downlink reference signals are transmitted in the radio resources in which the communication direction can be dynamically controlled in the uplink/downlink patterns 1 to 3 in the dynamic TDD described above with reference to FIG. 5, whereas in the adjacent cell, a transmission signal is muted so that no crosslink interference occurs in the radio resources in which the uplink and/or downlink reference signals are transmitted.

In other words, for the uplink reference signal, the transmitting and receiving unit 110 transmits the uplink reference signal generated by the signal processing unit 120 in the radio resources muted in the adjacent cell. For the downlink reference signal, the transmitting and receiving unit 210 transmits the downlink reference signal generated by the signal processing unit 220 in the radio resources muted in the adjacent cell.

As illustrated in FIG. 10, in one embodiment, for uplink transmission from a user equipment 102, the signal processing unit 120 may mute the uplink radio resources corresponding to the radio resources in which the downlink reference signal is transmitted at a transmission timing of the downlink reference signal from the base station 201 of the adjacent cell 301. On the other hand, for downlink transmission from the base station 201, the signal processing unit 220 mutes the downlink radio resources corresponding to the radio resources in which the uplink reference signal is transmitted at a transmission timing of the uplink reference signal from the user equipment 102 of the adjacent cell 302. In other words, as illustrated in FIG. 10, in order to prevent the crosslink interference, the user equipment 102 may mute the corresponding uplink radio resources on the basis of muting information for muting the corresponding uplink radio resources notified from a base station 202 of its own cell 302 at the timing at which the base station 201 of the adjacent cell 301 transmits the downlink reference signal such as the CSI-RS. Further, in order to prevent the crosslink interference, the base station 201 may mute the corresponding downlink radio resources in the cell 301 on the basis of configuration information indicating transmission information of the uplink reference signal by the user equipment 102 of the adjacent cell 302 notified from the base station 202 of the adjacent cell 302 (a transmission timing, a transmission frequency, and the like) at the timing at which the user equipment 102 of the adjacent cell 302 transmits the uplink reference signal such as the SRS. Accordingly, the user equipment 101 and the base station 202 can measure the communication qualities of the downlink channel and the uplink channel with no crosslink interference, respectively.

Here, the muting information may be notified, for example, through a physical control channel, a higher layer signal, or the like. Further, the configuration information may be notified between the base stations 201 and 202, for example, through backhaul signaling. Further, the base stations 201 and 202 may estimate the configuration information, for example, from the reference signals transmitted from the adjacent cells 302 and 301.

In one embodiment, as illustrated in FIG. 11, for the uplink transmission from the user equipment 102, the signal processing unit 120 may mute the uplink radio resources corresponding to the radio resources in which the downlink reference signal is transmitted at a transmission frequency of the downlink reference signal from the base station 201 of the adjacent cell 301. On the other hand, for the downlink transmission, the signal processing unit 220 may mute the downlink radio resources corresponding to the radio resources in which the uplink reference signal is transmitted at a transmission frequency of the uplink reference signal from the user equipment 102 of the adjacent cell 302. In other words, as illustrated in FIG. 11, in order to prevent the crosslink interference, the user equipment 102 may mute the corresponding uplink radio resources on the basis of the muting information notified from the base station 202 of its own cell 302 at the frequency band in which the base station 201 of the adjacent cell 301 transmits the downlink reference signal such as the CSI-RS. Further, in order to prevent the crosslink interference, the base station 201 may mute the corresponding downlink radio resources in the cell 301 on the basis of the configuration information indicating the transmission information of the uplink reference signal by the user equipment 102 of the adjacent cell 302 notified from the base station 202 of the adjacent cell 302 (a transmission timing, a transmission frequency, and the like) at the frequency band in which the user equipment 102 of the adjacent cell 302 transmits the uplink reference signal such as the SRS. Accordingly, the user equipment 101 and the base station 202 can measure the communication qualities of the downlink channel and the uplink channel with no crosslink interference, respectively. Here, in the illustrated embodiment, the uplink reference signal and the downlink reference signal are simultaneously transmitted in the uplink transmission and the downlink transmission, but the present invention is not limited thereto, and the uplink reference signal and the downlink reference signal may be transmitted at different timings.

Here, the muting information may be notified, for example, through a physical control channel, a higher layer signal, or the like. Further, the configuration information may be notified between the base stations 201 and 202, for example, through backhaul signaling. Further, the base stations 201 and 202 may estimate the configuration information, for example, from the reference signals transmitted from the adjacent cells 302 and 301.

The muting information may be notified to the user equipment 102 dynamically through the downlink control channel or the like or may be notified to the user equipment 102 in the RRC or the like in a semi-static manner.

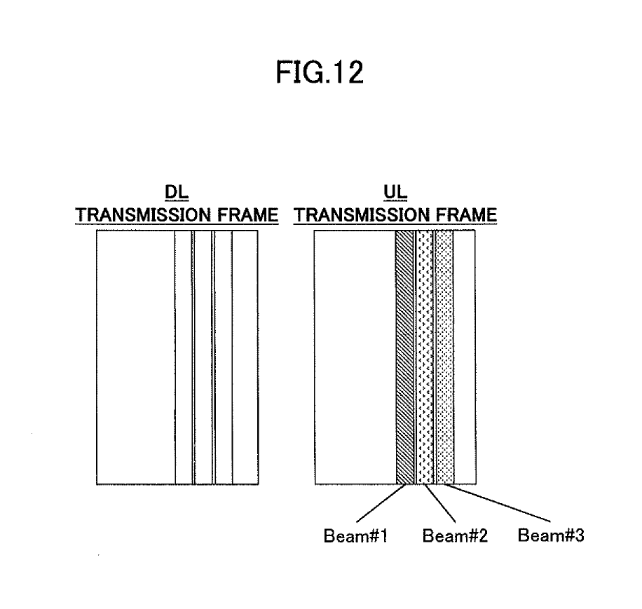

In the above-described embodiments, the SRS and the CSI-RS are used as the reference signal, but the present invention is not limited thereto, and for example, a reference signal to which beam forming is applied (for example, a BRS) may be similarly applied to the reference signal. In this case, the radio resources to be muted may be decided in accordance with a type of reference signal. For example, as illustrated in FIG. 12, when the user equipment 100 transmits the beam-formed uplink reference signals to which pre-coding has been applied to base station 200 through a plurality of beams, the base station 200 of the adjacent cell may mute the corresponding downlink radio resources.

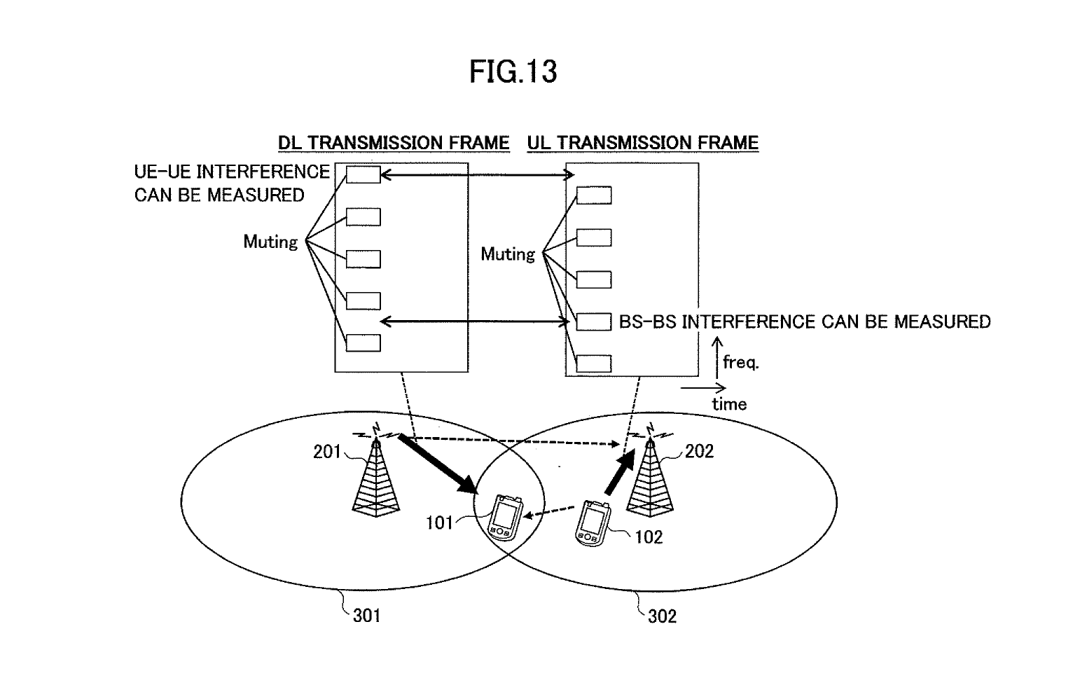

Next, mapping of the reference signal to the radio resources in the dynamic TDD according to a third embodiment of the present invention is described with reference to FIG. 13. In the first embodiment and the second embodiment, the channel quality in the dynamic TDD is intended to be accurately measured, but in the third embodiment, inter-cell interference including the crosslink interference is intended to be measured using muting in the dynamic TDD.

In other words, for the uplink transmission from the user equipment 102, the transmitting and receiving unit 110 may mute the uplink signal generated by the signal processing unit 120 in the radio resources in which the downlink signal is transmitted in the adjacent cell 201. On the other hand, for the downlink transmission from the base station 201, the transmitting and receiving unit 210 may muting the downlink signal generated by the signal processing unit 220 in the radio resources in which the uplink signal is transmitted in the adjacent cell 302. In other words, for the user equipment 102 located between the adjacent cells and the base station 201, the radio resources of the other cell corresponding to the radio resources in which the reference signal is transmitted in one cell are muted.

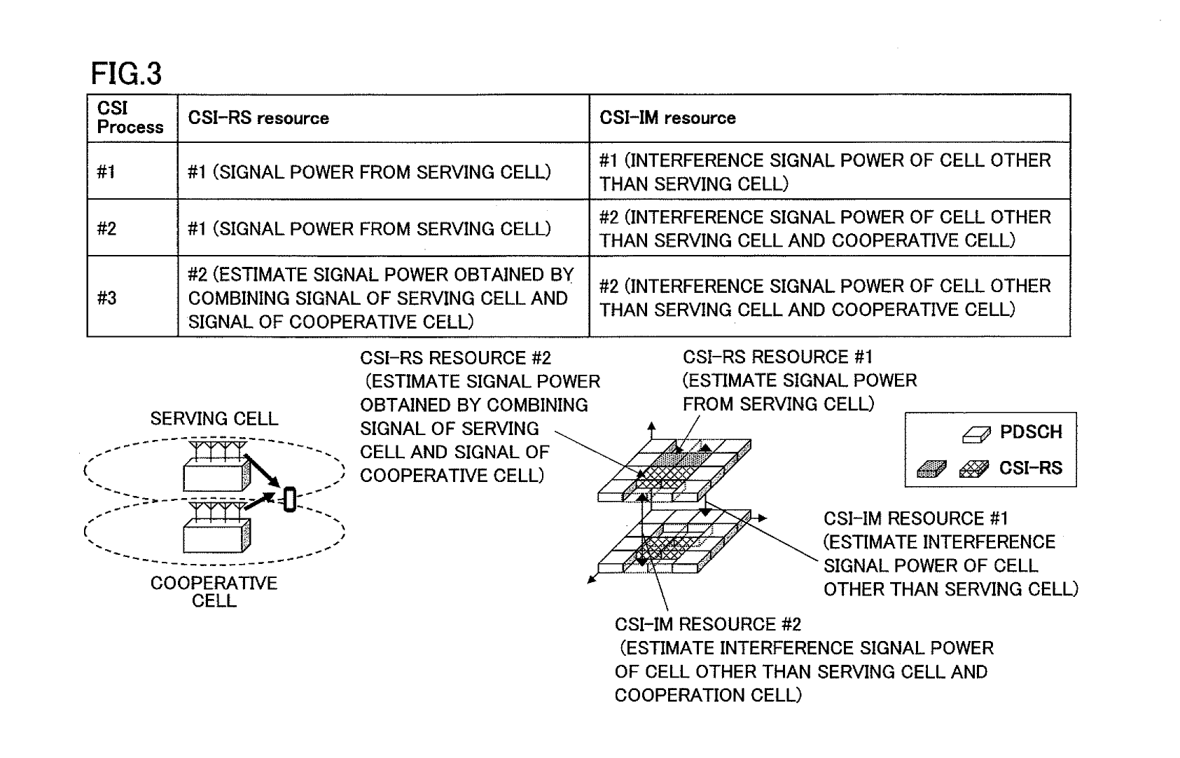

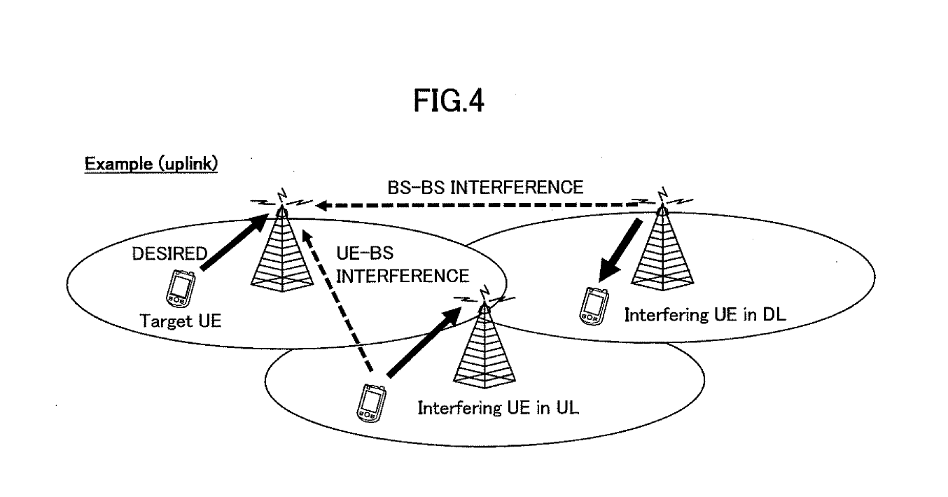

For example, as illustrated in FIG. 13, when the base station 201 transmits the downlink signal such as the downlink reference signal through the illustrated radio resources, the user equipment 102 of the adjacent cell 302 mutes the corresponding uplink radio resources. On the other hand, when the user equipment 102 transmits the uplink signal such as the uplink reference signal through the illustrated radio resources, the base station 201 of the adjacent cell 301 mutes the corresponding downlink radio resources. Specifically, similarly to the case of a plurality of CSI processes of Rel-11 described above with reference to FIG. 3, a plurality of CST processes may be defined, and uplink and downlink reference signals of zero power and non-zero power may be combined, and the inter-cell interference including the crosslink interference may be measured in the dynamic TDD.

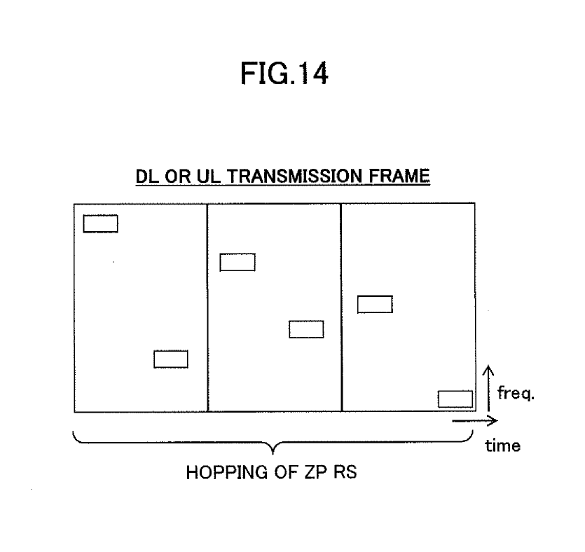

Further, the reference signal may be mapped by a hopping pattern illustrated in FIG. 14, and the inter-cell interference may be measured. By using such a hopping pattern, it is possible to measure the inter-cell interference at the entire frequency band.

Further, the third embodiment may be used alone or may be used in combination with the first embodiment or the second embodiment. In this case, the channel quality can be measured with a high degree of accuracy according to first embodiment or the second embodiment, and the cross link interference can be measured according to third embodiment.

The above embodiments have been described in connection with the dynamic TDD, but the present invention is not limited thereto and may be applied to any communication scheme in which the uplink communication and the downlink communication are dynamically switched in the time domain. Further, the present invention may be applied to any communication scheme in which radio resources are dynamically switched to the uplink communication and the downlink communication such as dynamic FDD in which the uplink communication and the downlink communication are switched in the frequency domain or the full duplex.

In the block diagrams used in the description of the above embodiment, the blocks of the functional units are illustrated. The functional blocks (configuring units) are implemented by an arbitrary combination of hardware and/or software. A device of implementing each functional block is not particularly limited. In other words, each functional block may be implemented by one device which is physically and/or logically combined or may be implemented by a plurality of devices, that is, two or more devices which are physically and/or logically separated and are directly and/or indirectly connected (for example, a wired and/or wireless manner).

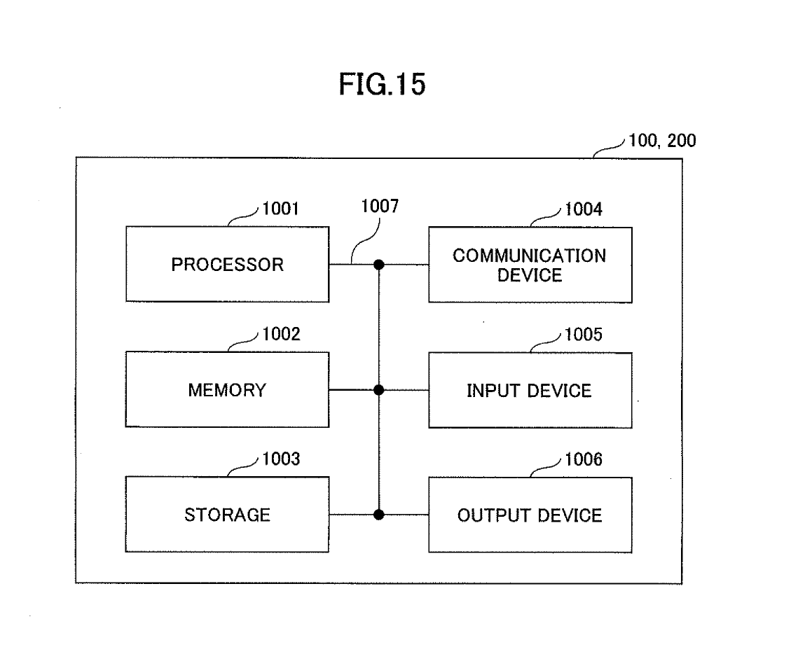

For example, each of the user equipment 100 and the base station 200 in one embodiment of the present invention may function as a computer that performs the process of the radio communication method of the present invention. FIG. 15 is a block diagram illustrating a hardware configuration of each of the user equipment 100 and the base station 200 according to one embodiment of the present invention. Each of the user equipment 100 and base station 200 may be physically configured as a computer device that includes a processor 1001, a memory 1002, a storage 1003, a communication device 1004, an input device 1005, an output device 1006, a bus 1007, and the like.

In the following description, the term “device” can be replaced with a circuit, a device, a unit, or the like. The hardware configuration of each of the user equipment 100 and base station 200 may be configured to include one or more devices illustrated in the drawing or may be configured without including some devices.

Each function in each of the user equipment 100 and base station 200 is implemented such that predetermined software (program) is read on hardware such as the processor 1001 and the memory 1002, and the processor 1001 performs an operation and controls communication by the communication device 1004 or reading and/or writing of data in the memory 1002 and the storage 1003.

For example, the processor 1001 operates an operating system and controls the entire computer. The processor 1001 may be configured with a central processing unit (CPU) including an interface with a peripheral device, a control device, an operation device, a register, and the like. For example, each component described above may be implemented by the processor 1001.

Further, the processor 1001 reads a program (a program code), a software module, and data from the storage 1003 and/or the communication device 1004 out to the memory 1002, and performs various kinds of processes according to them. A program causing a computer to execute at least some of the operations described in the above embodiment is used as the program. For example, the process performed by each component of the user equipment 100 and the base station 200 may be implemented by a control program which is stored in the memory 1002 and operates on the processor 1001, or the other functional blocks may be similarly implemented. Various kinds of processes have been described as being performed by one processor 1001 but may be performed simultaneously or sequentially by two or more processors 1001. The processor 1001 may be implemented by one or more chips. The program may be transmitted from a network via an electric communication line.

The memory 1002 is a computer readable recording medium and configured with at least one of a read only memory (ROM), an erasable programmable ROM (EPROM), an electrically erasable programmable ROM (EEPROM), a random access memory (RAM), and the like. The memory 1002 is also referred to as a “register,” a “cache,” a “main memory (main storage device),” or the like. The memory 1002 can store programs (program codes), software modules, or the like which are executable for carrying out the radio communication method according to the embodiment of the present embodiment.

The storage 1003 is a computer-readable recording medium and may be configured with, for example, at least one of an optical disk such as a compact disc ROM (CD-ROM), a hard disk drive, a flexible disk, a magneto-optical disk (for example, a compact disk, a digital versatile disk, or a Blu-ray (registered trademark) disc, a smart card, a flash memory (for example, a card, a stick, or a key drive), a floppy (registered trademark) disk, a magnetic strip, and the like. The storage 1003 is also referred to as an “auxiliary storage device.” The storage medium may be, for example, a database, a server, or any other appropriate medium including the memory 1002 and/or the storage 1003.

The communication device 1004 is hardware (a transmitting and receiving device) for performing communication between computers via a wired and/or wireless network and is also referred to as a “network device,” a “network controller,” a “network card,” a “communication module,” or the like. For example, each component described above may be implemented by the communication device 1004.

The input device 1005 is an input device that receives an input from the outside (such as a keyboard, a mouse, a microphone, a switch, a button, a sensor, or the like). The output device 1006 is an output device that performs an output to the outside (for example, a display, a speaker, an LED lamp, or the like). The input device 1005 and the output device 1006 may be integrally configured (for example, a touch panel).

The respective devices such as the processor 1001 or the memory 1002 are connected via the bus 1007 to communicate information with each other. The bus 1007 may be configured with a single bus or may be configured with different buses between the devices.

Further, each of the user equipment 100 and the base station 200 may be configured to include hardware such as a microprocessor, a digital signal processor (DSP), an application specific integrated circuit (ASIC), a programmable logic device (PLD), or a field programmable gate array (FPGA) or all or some of the functional blocks may be implemented by hardware. For example, the processor 1001 may be implemented by at least one of these pieces of hardware.

A notification of information is not limited to the aspect or embodiment described in this specification and may be given by any other method. For example, the notification of information may be given physical layer signaling (for example, Downlink Control Information (DCI), uplink control information (UCI)), higher layer signaling (for example, radio resource control (RRC) signaling, medium access control (MAC) signaling, broadcast information (master information block (MIB), system information block (SIB))), other signals, or a combination thereof. Further, the RRC signaling may be referred to as an “RRC message” and may be, for example, an RRC connection setup message, an RRC connection reconfiguration message, or the like.

Each aspect and embodiment described in this specification is applicable to LTE, LTE-A, SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), and systems using any other appropriate systems and/or next generation systems expanded on the basis of the systems.

The processing procedures, the sequences, the flowcharts, and the like of the respective aspects/embodiments described in this specification may be reversed in order unless there is a contradiction. For example, the method described in this specification presents elements of various steps in an exemplary order and is not limited to a presented specific order.

In this specification, a specific operation that is supposed to be performed by the base station 200 may be performed by an upper node in some instance. In the network configured with one or more network nodes including the base station, various operations performed for communication with the terminal can be obviously performed by the base station and/or any network node other than the base station (for example, an MME, an S-GW, or the like is considered, but it is not limited thereto). The example in which the number of network nodes excluding the base station is one has been described above, but a combination of a plurality of other network nodes (for example, an MME and an S-GW) may be provided.

Information and the like can be output from the higher layer (or the lower layer) to the lower layer (or the higher layer). Information and the like may be input/output via a plurality of network nodes.

Input and output information and the like may be stored in a specific place (for example, a memory) or may be managed through a management table. Input and output information and the like may be overwritten, updated, or additionally written. Output information and the like may be deleted. Input information and the like may be transmitted to another device.

The determination may be performed in accordance with a value (0 or 1) indicated by one bit, may be performed in accordance with a Boolean value (true or false), or may be performed by a comparison of numerical values (for example, a comparison with a value).

Each aspect/embodiment described in this specification may be used alone, may be used in combination, or may be switched in association with execution. Further, a notification of predetermined information (for example, a notification indicating “being X”) is not limited to one which is performed explicitly and may be performed implicitly (for example, a notification of predetermined information is not given).

Although the present invention has been described above in detail, it is obvious to those having skill in the art that the present invention is not limited to the embodiments described in this specification. The present invention can be carried out as revisions and modifications without departing from the gist and scope of the present invention decided in claims set forth below. Therefore, the description of this specification is intended to be exemplary and does not have any restrictive meaning to the present invention.

Software can be interpreted widely to mean a command, a command set, a code, a code segment, a program code, a program, a subprogram, a software module, an application, a software application, a software package, a routine, a subroutine, an object, an executable file, an execution thread, a procedure, a function, and the like regardless of whether software is called software, firmware, middleware, a microcode, a hardware description language, or any other name.

Further, software, commands, and the like may be transmitted and received via a transmission medium. For example, when software is transmitted from a web site, a server, or any other remote source using a wired technology such as a coaxial cable, a fiber optic cable, a twisted pair, or a digital subscriber line (DSL) and/or a radio technology such as infrared rays, a radio wave, or a microwave, the wired technology and/or the radio technology are included in a definition of a transmission medium.

Information, signals, and the like described in this specification may be indicated using any one of a variety of different techniques. For example, data, instructions, commands, information, signals, bits, symbols, chips, and the like which are mentioned throughout the above description may be indicated by voltages, currents, electromagnetic waves, magnetic particles, optical fields or photons, or an arbitrary combination thereof.

The terms described in this specification and/or terms necessary for understanding this specification may be replaced with terms having the same or similar meanings. For example, a channel and/or a symbol may be a signal. Further, a signal may be a message. Further, a component carrier (CC) may be referred to as a “carrier frequency,” a “cell,” or the like.

The terms “system” and “network” used in this specification are used interchangeably.

Further, information, parameters, and the like described in this specification may be indicated by absolute values, may be indicated by relative values from predetermined values, or may be indicated by corresponding other information. For example, radio resources may be those indicated by an index.

The names used for the above-described parameters are not limited in any respect. Further, mathematical formulas or the like using the parameters may be different from those explicitly disclosed in this specification. Since various channels (for example, the PUCCH, the PUCCH, and the like) and information elements (for example, the TPC or the like) can be identified by suitable names, the various names allocated to the various channels and the information elements are not limited in any respect.

The base station can accommodate one or more (for example, three) cells (which is also referred to as “sectors”). When the base station accommodates a plurality of cells, the entire coverage area of the base station can be partitioned into a plurality of small areas, and each small area can provide a communication service through a base station subsystem (for example, a small indoor base station remote radio head (RRH)). The term “cell” or “sector” refers to a part or all of the coverage area of the base station and/or the base station subsystem that performs communication service in the coverage. Further, the terms “base station”, “radio base station,” “eNB”, “cell,” and “sector” may be used interchangeably in this specification. The base station is also referred to as a “fixed station,” a “Node B,” an “eNode B (eNB),” an “access point,” a “Femto cell,” a “small cell,” a “transmission point (TP),” a “transmission/reception point (TRP),” or the like.

A mobile station is also referred to as a subscriber station, a mobile unit, a subscriber unit, a radio unit, a remote unit, a mobile device, a wireless device, a radio communication device, a remote device, a mobile subscriber station, an access terminal, a mobile terminal, a radio terminal, a remote terminal, a handset, a user agent, a mobile client, a client, or other appropriate terms, depending on those having skill in the art.

The terms “determining” and “deciding” used in this specification may include a wide variety of actions. For example, “determining” and “deciding” may include, for example, events in which events such as calculating, computing, processing, deriving, investigating, looking up (for example, looking up in a table, a database, or another data structure), or ascertaining are regarded as “determining” or “deciding.” Further, “determining” and “deciding” may include, for example, events in which events such as receiving (for example, receiving information), transmitting (for example, transmitting information), input, output, or accessing (for example, accessing data in a memory) are regarded as “determining” or “deciding.” Further, “determining” and “deciding” may include, for example, events in which events such as resolving, selecting, choosing, establishing, or comparing are regarded as “determining” or “deciding.” In other words, “determining” and “deciding” may include events in which a certain operation is regarded as “determining” or “deciding.”

Terms “connected,” “coupled,” or variations thereof means any direct or indirect connection or coupling between two or more elements and may include the presence of one or more intermediate elements between two elements which are “connected” or “coupled.” The coupling or the connection between the elements may be physical, logical, or a combination thereof. When used in this specification, two elements may be considered to be “connected” or “coupled” with each other using one or more electric wires, cables and/or a printed electrical connection or using electromagnetic energy such as electromagnetic energy having a wavelength in a radio frequency domain, a microwave region, or a light (both visible and invisible) region as non-limiting and non-exhaustive examples.

A reference signal may be abbreviated as RS and may be called a pilot, depending on a standard to be applied.

A phrase “on the basis of” used in this specification is not limited to “on the basis of only” unless otherwise stated. In other words, a phrase “on the basis of” means both “on the basis of only” and “on the basis of at least.”

Any reference to an element using a designation such as “first,” “second,” or the like used in this specification does not generally restrict quantities or an order of those elements. Such designations can be used in this specification as a convenient method of distinguishing between two or more elements. Thus, reference to the first and second elements does not mean that only two elements can be adopted there, or first element must precede the second element in a certain form.

Further, “means” in the configuration of each of the above devices may be replaced with “unit,” “circuit,” “device,” or the like.

“Include,” “including,” and variations thereof are intended to be comprehensive, similarly to a term “equipped with” as long as the terms are used in this specification or claims set forth below. Furthermore, the term “or” used in this specification or claims set forth below is intended not to be an exclusive disjunction.

A radio frame may be configured with one or more frames in the time domain. Each of one or more frames in the time domain is also referred to as a subframe. Further, the subframe may be configured with one or more slots in the time domain. Further, the slot may be configured with one or more symbols (OFDM symbols, SC-FDMA symbols, or the like) in the time domain. Each of the radio frame, the subframe, the slot, and the symbol indicate a time unit when signals are transmitted. The radio frame, the subframe, the slot, and the symbol may have different corresponding names. For example, in an LTE system, the base station performs scheduling to allocate radio resources (a frequency bandwidth, transmission power or the like usable in each mobile station) to each mobile station. A minimum time unit of scheduling may be referred to as a transmission time interval (TTI). For example, one subframe may be referred to as a TTI, a plurality of consecutive subframes may be referred to as a TTI, or one slot may be referred to as a TTI. The resource block (RB) is a resource allocation unit in the time domain and the frequency domain and may include one or more consecutive subcarriers in the frequency domain. In the time domain of the resource block, one or more symbols may be included, and one slot, one subframe, or one TTI may be used. Each of one TTI and one subframe may be configured with one or more resource blocks. The structure of the radio frame described above is merely an example, and the number of subframes included in the radio frame, the number of slots included in the subframe, the number of symbols and resource blocks included in the slot, and the number of subcarriers included in the resource block can be changed variously.

The embodiments of the present invention are described above in detail, but the present invention is not limited to the specific embodiments described above, and various modifications and alterations may be made within the scope of the gist of the present invention set forth in claims.

This patent application is based on and claims priority to Japanese Patent Application No. 2016-215711 filed on Nov. 2, 2016, and the entire content of Japanese Patent Application No. 2016-215711 is incorporated herein by reference.

### LIST OF REFERENCE SYMBOLS

10 radio communication system
100 user equipment
200 base station
110, 210 transmitting and receiving unit
120, 220 signal processing unit

1. A user equipment, comprising:
a transmitting and receiving unit that performs transmission and reception of a radio signal with a base station in accordance with a communication scheme in which uplink communication and downlink communication are dynamically switched; and
a signal processing unit that processes the radio signal,
wherein the transmitting and receiving unit transmits an uplink reference signal generated by the signal processing unit in fixed uplink radio resources in the communication scheme.

2. A base station, comprising:
a transmitting and receiving unit that performs transmission and reception of a radio signal with a user equipment in accordance with a communication scheme in which uplink communication and downlink communication are dynamically switched; and
a signal processing unit that processes the radio signal,
wherein the transmitting and receiving unit transmits a downlink reference signal generated by the signal processing unit in fixed downlink radio resources in the communication scheme.

3. A user equipment, comprising:
a transmitting and receiving unit that performs transmission and reception of a radio signal with a base station in accordance with a communication scheme in which uplink communication and downlink communication are dynamically switched; and
a signal processing unit that processes the radio signal,
wherein the transmitting and receiving unit transmits an uplink reference signal generated by the signal processing unit in radio resources muted in an adjacent cell.

4. The user equipment according to claim 3,
wherein the transmitting and receiving unit mutes uplink radio resources based on muting information received from the base station.

5. A base station, comprising:
a transmitting and receiving unit that performs transmission and reception of a radio signal with a user equipment in accordance with a communication scheme in which uplink communication and downlink communication are dynamically switched; and
a signal processing unit that processes the radio signal,
wherein the transmitting and receiving unit transmits a downlink reference signal generated by the signal processing unit in radio resources muted in an adjacent cell.

6. The base station according to claim 5,
wherein the transmitting and receiving unit notifies the user equipment of muting information for muting radio resources corresponding to the base station's cell based on configuration information received from a base station of the adjacent cell.

7. A user equipment, comprising:
a transmitting and receiving unit that performs transmission and reception of a radio signal with a base station in accordance with a communication scheme in which uplink communication and downlink communication are dynamically switched; and
a signal processing unit that processes the radio signal,
wherein the transmitting and receiving unit mutes an uplink signal generated by the signal processing unit in radio resources in which a downlink signal is transmitted in an adjacent cell.

8. A base station, comprising:
a transmitting and receiving unit that performs transmission and reception of a radio signal with a user equipment in accordance with a communication scheme in which uplink communication and downlink communication are dynamically switched; and
a signal processing unit that processes the radio signal,
wherein the transmitting and receiving unit mutes a downlink signal generated by the signal processing unit in radio resources in which an uplink signal is transmitted in an adjacent cell.
